(19) United States
(12) Patent Application Publication
(10) Pub. No.: US 2006/0066205 A1
(43) Pub. Date: Mar. 30, 2006

(54) Color picture tube apparatus

(75) Inventor: Etsuji Tagami, Takatsuki-shi (JP)

Correspondence Address: HAMRE, SCHUMANN, MUELLER & LARSON, P.C., P.O. BOX 2902-0902, MINNEAPOLIS, MN, 55402, US

(73) Assignee: Matsushita Toshiba Picture Display Co. Ltd., Takatsuki-shi (JP)

(21) Appl. No.: 11/237,381

(22) Filed: Sep. 28, 2005

(30) Foreign Application Priority Data
Sep. 30, 2004 (JP) 2004-288010

(51) Int. Cl. H01J 29/70

(52) U.S. Cl. 313/440

(57) ABSTRACT

The present invention provides a color picture tube apparatus in which YV and top and bottom trapezoidal distortions can be adjusted optimally even in a toroidal coil. A deflection yoke includes a horizontal deflection coil, a vertical deflection coil, and a ferrite core. The ferrite core is divided into an upper core 6 and a lower core 7. The vertical deflection coil is toroidally wound around each of the upper core 6 and the lower core 7. An upper core left coil 32 and an upper core right coil 34 are separated via a first intermediate tap 15, and a lower core left coil 34 and a lower core right coil 35 are separated via a second intermediate tap 26. A variable resistor that is connected to each of the coils in parallel and that is connected to at least either of the first or second intermediate tap 15 or 26 is provided.

### BACKGROUND OF THE INVENTION

1. Field of the Invention

The present invention relates to a color picture tube apparatus used in televisions or computer displays, for example, and more specifically relates to a deflection yoke used in the color picture tube apparatus.

2. Description of Related Art

In cathode ray tube apparatuses, a deflection yoke is provided so as to surround the outer periphery of a cone component of a glass funnel constituting a vacuum envelope. Three electron beams emitted from an electron gun are deflected by horizontal and vertical deflection magnetic fields generated by the deflection yoke, and then are scanned horizontally and vertically over a fluorescent screen through a shadow mask, which results in the display of a color image. The deflection yoke includes a vertical deflection coil and a horizontal deflection coil, and the vertical deflection coil usually is wound around a ferrite core.

FIG. 6 is a cross-sectional view of an example of a ferrite core around which a conventional vertical deflection coil is wound. FIG. 6 shows the cross section in a direction orthogonal to the tube axis of a cathode ray tube, and the X axis is an axis extending in the horizontal direction of the screen and the Y axis is an axis extending in the vertical direction of the screen, which also applies to FIG. 7.

A plurality of salient portions 51 projecting toward the tube axis is provided on the inner surface of a ferrite core 50. A vertical deflection coil 53 is wound around indented portions 52 between the salient portions 51. With this configuration, as compared to a configuration in which the salient portions 51 are not provided, the ferrite core 50 can be closer to the cathode ray tube, so that the deflection sensitivity can be increased, which is advantageous in terms of reducing the deflection power.

Moreover, the magnetic flux does not pass through the coil easily, and eddy-current loss decreases, so that it also is possible to reduce the heat generated by the deflection yoke. The ferrite core 50 such as this is referred to as a “slot core”, and the same configuration also is disclosed in JP S61-56757U.

FIG. 7 is a cross-sectional view of another example of a ferrite core around which the conventional vertical deflection coil is wound. The example shown in FIG. 7 is a ferrite core of a saddle-toroidal type deflection yoke (STDY). The horizontal deflection coil is a saddle coil (not shown) made by winding a wire by a mold, and the vertical deflection coil 61 is a toroidal coil directly wound around a ferrite core 60. Since the ferrite core 60 is divided into upper and lower sides, the vertical deflection coil 61 is divided into upper and lower sides.

Here, the reason why the core of the toroidal coil is vertically divided will be described. First, the wire of the toroidal coil of the vertical deflection coil is wound around the core, excluding a region of about ±20° from the horizontal axis, to provide the optimum magnetic field distribution. The wire of the toroidal coil is wound with one side of the divided core being held by one of the dividing surfaces. In order to secure a space for this holding mechanism during winding, the wire cannot be wound around a range from the dividing surface to 18° (this range is referred to as “dead zone”).

Regarding this dead zone, if the core is divided into left and right sides, then the dividing surfaces are on the vertical axis, so that the wire cannot be wound around a range of ±18° from the vertical axis, i.e., the wire cannot be wound near the vertical axis, and thus, a desired magnetic field distribution cannot be obtained.

On the other hand, if the core is divided into upper and lower sides, then the dividing surfaces are on the horizontal axis, so that the wire cannot be wound around a range of ±18° from the horizontal axis. However, as described above, since the wire of the toroidal coil has to be wound so as to provide a winding distribution on the core excluding the region of about ±20° from the horizontal axis, a desired magnetic field distribution can be obtained.

Next, adjustment of YV and trapezoidal distortion using a differential resistor will be described. “YV” refers to a pattern of misconvergence, and more specifically to a pattern in which R (red) and B (blue) are offset from their proper position and do not overlap each other, as shown in FIG. 9. When the vertical coil is a saddle coil, it does not need the core and is a horizontally-divided type. Thus, as shown in FIG. 8, a left saddle coil 46 and a right saddle coil 47 are connected in series, and the balance of the current flowing through the left and right coils can be changed by a differential resistor 48. In this manner, it is possible to simulate the effect of left and right tilt with respect to the vertical coil.

With this configuration, YV misconvergence and top and bottom trapezoidal distortions can be varied, and thus, YV and trapezoidal distortion, which occur when a cathode ray tube and a deflection yoke are combined, can be adjusted optimally.

In addition to the foregoing techniques, there is a technique for reducing noise, called “ringing”, that is caused by the voltage induced from the horizontal coil to the vertical coil, by connecting a damping resistor to the vertical coil in parallel so that the damping resistor serves as a filter that reduces the noise component.

In particular, JP H6-139959A proposes a technique for removing ringing in which, in a winding method called the “multi-layer winding method”, in which after each layer of wire turns is completely wound, the wire is returned to its initial winding position, intermediate taps are made halfway through a winding layer, and a damping circuit constituted by a resistor and a capacitor is connected to them.

However, regarding the toroidal coil as described above that is made by winding the wire around the core to form multiple layers of wire turns, there has been a problem in that since the core is of a vertically-divided type, it is not possible to adjust YV and top and bottom trapezoidal distortions by dividing the vertical coil into left and right sides and balancing the current therebetween.

### SUMMARY OF THE INVENTION

The present invention has been achieved to solve the foregoing conventional problem, and it is an object of the present invention to provide a color picture tube in which YV and top and bottom trapezoidal distortions are small even in a toroidal coil.

In order to attain the object, the color picture tube apparatus according to the present invention includes a cathode ray tube and a deflection yoke that is disposed so as to surround the exterior of the cathode ray tube, in which three electron beams emitted from an electron gun are deflected by a horizontal deflection magnetic field and a vertical deflection magnetic field of the deflection yoke to form a color image on a screen. The deflection yoke includes a horizontal deflection coil, a vertical deflection coil, and a ferrite core. The ferrite core is divided into an upper core and a lower core, and the vertical deflection coil is wound toroidally around each of the upper core and the lower core. When an axis that passes through a tube axis of the cathode ray tube and extends in a vertical direction of the screen is taken as the Y axis, and an axis that passes through the tube axis and extends in a horizontal direction of the screen is taken as the X axis, and when the ferrite core is viewed from the screen side, when a coil of the vertical deflection coil that is wound around a region located at the left of the Y axis and above the X axis is taken as an upper core left coil, a coil of the vertical deflection coil that is wound around a region located at the right of the Y axis and above the X axis is taken as an upper core right coil, a coil of the vertical deflection coil that is wound around a region located at the left of the Y axis and below the X axis is taken as a lower core left coil, and a coil of the vertical deflection coil that is wound around a region located at the right of the Y axis and below the X axis is taken as a lower core right coil, the upper core left coil and the upper core right coil are separated via a first intermediate tap, and the lower core left coil and the lower core right coil are separated via a second intermediate tap. A variable resistor that is connected to at least either of the first or second intermediate tap is provided.

### BRIEF DESCRIPTION OF THE DRAWINGS

FIG. 1 is an external view of a color picture tube according to an embodiment of the present invention.

FIG. 2 shows a cross section of a ferrite core according to the embodiment of the present invention when viewed from the screen side.

FIG. 3 is a connection diagram of a vertical coil according to the embodiment of the present invention.

FIG. 4 shows a perspective view of an example of a ferrite core having the guide.

FIG. 5 is a connection diagram of another vertical coil according to the embodiment of the present invention.

FIG. 6 is a cross-sectional view showing an example of a conventional ferrite core.

FIG. 7 is a cross-sectional view showing another example of the conventional ferrite core.

FIG. 8 shows an example of a connection diagram of a conventional vertical saddle coil.

FIG. 9 is a diagram for describing patterns of YV misconvergence.

### DETAILED DESCRIPTION OF THE INVENTION

According to the present invention, the vertical deflection coil is divided into the left coils and the right coils via the intermediate taps, so that YV and top and bottom trapezoidal distortions can be adjusted optimally even in a toroidal coil.

In the color picture tube apparatus according to the present invention, it is preferable that the ferrite core is a slot core on the inside or outside of which salient portions are formed. With this configuration, the wire can be wound in an aligned manner around the groove portions, so that it is possible to divide the vertical deflection coil into left and right sides while suppressing the generation of ringing.

Moreover, it is preferable that a guide for regulating the winding position is added to the ferrite core. With this configuration, the wire can be wound in an aligned manner more reliably.

Moreover, in the color picture tube apparatus according to the present invention, it is preferable that the upper core left coil and the lower core left coil are connected in series to form a left coil group, the upper core right coil and the lower core right coil are connected in series to form a right coil group, the left coil group and the right coil group are connected in series, and the variable resistor is connected to the first and second intermediate taps; and a difference in current between the left coil group and the right coil group can be generated by the variable resistor. With this configuration, it is possible to adjust YV and top and bottom trapezoidal distortions by varying the current balance between the upper core left coil and the lower core left coil, which are on the left side, and the upper core right coil and the lower core right coil, which are on the right side.

Moreover, it is preferable that the variable resistor is separated into a first variable resistor and a second variable resistor; the upper core left coil and the upper core right coil are connected in series, and the first intermediate tap is connected to the first variable resistor; the lower core left coil and the lower core right coil are connected in series, and the second intermediate tap is connected to the second variable resistor; and a difference in current between the upper core left coil and the upper core right coil can be generated by the first variable resistor, and a difference in current between the lower core left coil and the lower core right coil can be generated by the second variable resistor. With this configuration, YV and top and bottom trapezoidal distortions can be adjusted in the upper core side and the lower core side independently.

Moreover, it is preferable that the first variable resistor and the second variable resistor are configured such that varying operations of the variable resistors are linked together.

Moreover, it is preferable that the first variable resistor and the second variable resister are configured such that varying operations of the variable resistors are linked together via an adjustment bar.

According to the present invention, YV and top and bottom trapezoidal distortions can be adjusted optimally even in a toroidal coil.

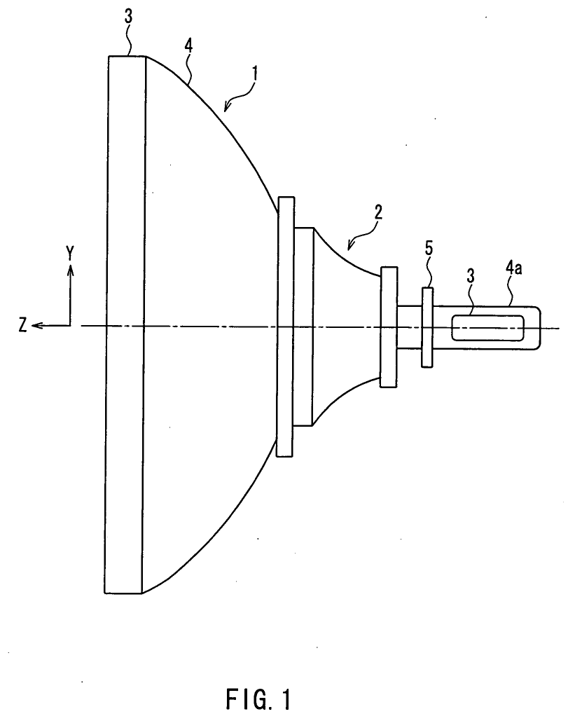

Hereinafter, an embodiment of the present invention will be described with reference to the drawings. FIG. 1 is a side view of a color picture tube apparatus according to the embodiment of the present invention. The color picture tube apparatus shown in FIG. 1 includes a cathode ray tube 1 and a deflection yoke 2. The cathode ray tube 1 includes an envelope and components carried by the envelope. The envelope is constituted by a front flat panel 3 on the inner surface of which a screen plane is formed and a funnel 4. An electron gun 3 that emits three electron beams is provided inside a neck component 4a of the funnel 4.

Moreover, the deflection yoke 2 and a convergence yoke 5 are installed so as to surround the exterior of the funnel 4. The deflection yoke 2 includes a horizontal deflection coil and a vertical deflection coil, and the three electron beams emitted from the electron gun 3 are deflected horizontally and vertically by horizontal and vertical deflection magnetic fields generated by these coils. In this manner, the three electron beams are scanned horizontally and vertically over the screen plane through a shadow mask (not shown), which results in the display of a color image.

In the following description, an axis that passes through the tube axis (Z axis) of the cathode ray tube 1 and that extends in the vertical direction of the screen is taken as the Y axis, and an axis that passes through the tube axis and that extends in the horizontal direction of the screen is taken as the X axis. Moreover, the Y axis when the deflection yoke 2 is viewed from the screen side is used as a reference for determining the right side and the left side. Also, the X axis is used as a reference for determining the upper side and the lower side.

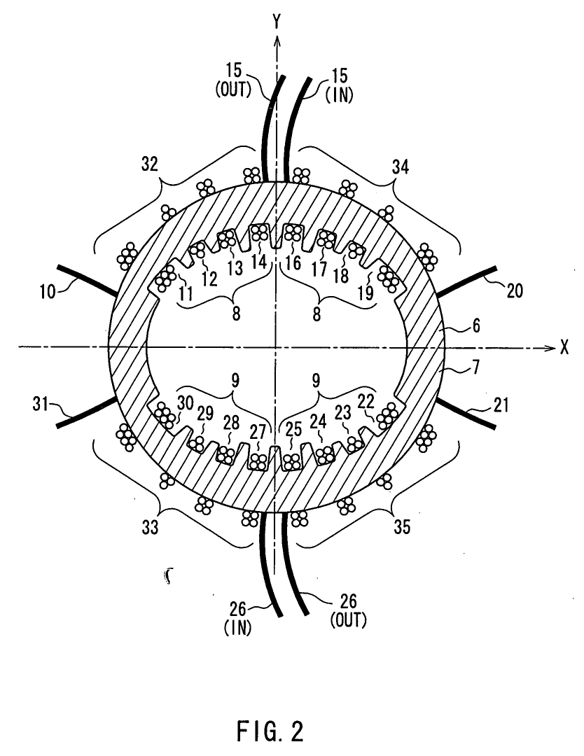

FIG. 2 is a cross-sectional view of a ferrite core according to the embodiment of the present invention, around which the vertical deflection coil is wound. FIG. 2 shows the cross section in a direction orthogonal to the tube axis, when viewed from the screen side.

The ferrite core is a slot core on the inside of which salient portions are formed, and is vertically divided into an upper core 6 and a lower core 7 as X axis for boundary. Correspondingly, an upper coil 8 and a lower coil 9 are wound independently around the upper core 6 and the lower core 7, respectively. After winding the upper core 6 and the lower core 7 are combined, and the combination is maintained with a clip or the like.

Although the slot core on the inside of which the salient portions are formed is shown as an example in FIG. 2, a slot core on the outside of which salient portions are formed or a slot core on both the inside and outside of which salient portions are formed may be used.

First, a process of winding of the upper coil 8 will be described. The upper coil 8 is wound around the upper core 6 in order from the left side to the right side using a progressive winding method. The salient portions are formed on the inside of the upper coil 8, and grooves 11 to 14 and 16 to 19 are formed between the salient portions. A wire 10 corresponds to a wire at the winding start position. From the position of the wire 10, the wire is first wound in an aligned manner around the groove 11 on the extreme left so as to form three layers of wire turns, and after this, the wire is wound in the same manner around the slots 12, 13, and 14 in this order.

In the middle of the wire turns, that is to say, at the point of time when winding around the half to the left of the Y axis is completed, an intermediate tap (intermediate terminal) 15(OUT) is made. After making the intermediate tap 15(OUT), an intermediate tap 15(IN) is used as the start position, and then the wire is wound around the grooves 16, 17, 18, and 19 in this order, in the same manner as in the left half. At the position of a wire 20 corresponding to the winding finish position, toroidal winding of the upper coil 8 is completed.

The lower coil 9 is wound using the same method as the upper coil 8, that is, the lower coil 9 is wound around the lower core 7 in order from the right side to the left side using the progressive winding method. Salient portions also are formed on the inside of the lower core 7, and grooves 22 to 25 and 27 to 30 are formed between the salient portions. A wire 21 corresponds to a wire at the winding start position. From the position of the wire 21, the wire is first wound in an aligned manner around the groove 22 on the extreme right so as to form three layers of wire turns, and after this, the wire is wound in the same manner around the grooves 23, 24, and 25 in this order.

In the middle of the wire turns, that is to say, at the point of time when winding around the half to the right of the Y axis is completed, an intermediate tap 26(OUT) is made. After making the intermediate tap 26(OUT), an intermediate tap 26(IN) is used as the start position, and then the wire is wound around the grooves 27, 28, 29, and 30 in this order, in the same manner as in the right half. At the position of a wire 31 corresponding to the winding finish position, toroidal winding of the lower coil 9 is completed.

With the winding technique as described above, an upper core left coil 32 and an upper core right coil 34 are separated via the intermediate taps 15, and a lower core left coil 33 and a lower core right coil 35 are separated via the intermediate taps 26.

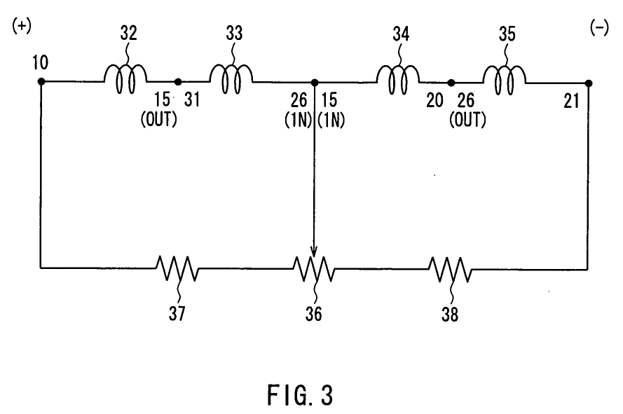

Next, wire connection of the vertical coil will be described with reference to FIGS. 2 and 3. FIG. 3 is a connection diagram of the vertical coil. In the configuration shown in FIG. 2, the upper coil 8 and the lower coil 9 are divided into left and right sides via the intermediate taps 15 and 26, respectively. As shown in FIG. 3, the intermediate tap 15(OUT) at the winding end of the upper core left coil 32 is connected to the wire 31 of the lower core left coil 33.

Moreover, the intermediate tap 26(IN) of the lower core left coil 33 is connected to the intermediate tap 15(IN) of the upper core right coil 34. Furthermore, the wire 20 of the upper core right coil 34 is connected to the intermediate tap 26(OUT) of the lower core right coil 35.

With this wire connection, the vertical deflection current first flows through the upper core left coil 32 from the wire 10 connected to the positive voltage side, then flows through the lower core left coil 33, the upper core right coil 34, and the lower core right coil 35 in this order, and finally flows out through the wire 21 of the lower core right coil 35 that is connected to the negative voltage side.

In the connection diagram shown in FIG. 3, a 100Ω trimmer potentiometer 36 is connected to the intermediate tap 15(IN) and the intermediate tap 26(IN). The trimmer potentiometer 36 serves as a differential resistor or variable resistor, and can adjust YV and top and bottom trapezoidal distortions by varying the current balance between the upper core left coil 32 and the lower core left coil 33, which are on the left side, and the upper core right coil 34 and the lower core right coil 35, which are on the right side.

Moreover, a 100Ω fixed resistor 37 serving as a damping resistor is connected to the upper core left coil 32 and the lower core left coil 33, which are on the left side, in parallel, and similarly a 100Ω fixed resistor 38 serving as a damping resistor is connected to the upper core right coil 34 and the lower core right coil 35, which are on the right side, in parallel. With this configuration, ringing can be suppressed more advantageously.

If the vertical coil is wound using an ordinary toroidal winding method and divided into left and right sides by simply making the intermediate taps, then ringing occurs easily. However, even when the wire is wound using a progressive winding method, if the core is a slot core, then the wire is wound in an aligned manner around the groove portions, so that ringing, which is caused easily by, for example, asymmetry of the winding, hardly occurs. Thus, according to the present embodiment, it is possible to divide the vertical deflection coil into left and right sides while suppressing generation of ringing.

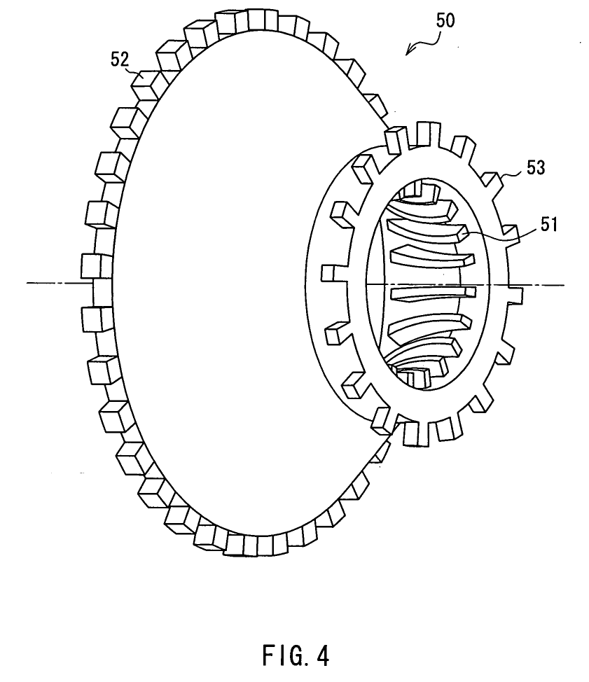

Also, when a guide for regulating the winding position is attached on the screen side end and the electron gun side end of the ferrite core, the wire can be wound in an aligned manner, so that as in the case where the slot core is used, ringing, which is easily caused by, for example, asymmetry of the winding, hardly occurs. Moreover, if the guide is attached to the slot core, then the wire can be wound in an aligned manner more reliably. FIG. 4 shows a perspective view of an example of a ferrite core having the guide. The ferrite core 50 in FIG. 4 is an example of a ferrite core on the inside of which salient portion 51 are formed. This ferrite core 50 has the guide 52 on the screen side end, and the guide 53 on the electron gun side end.

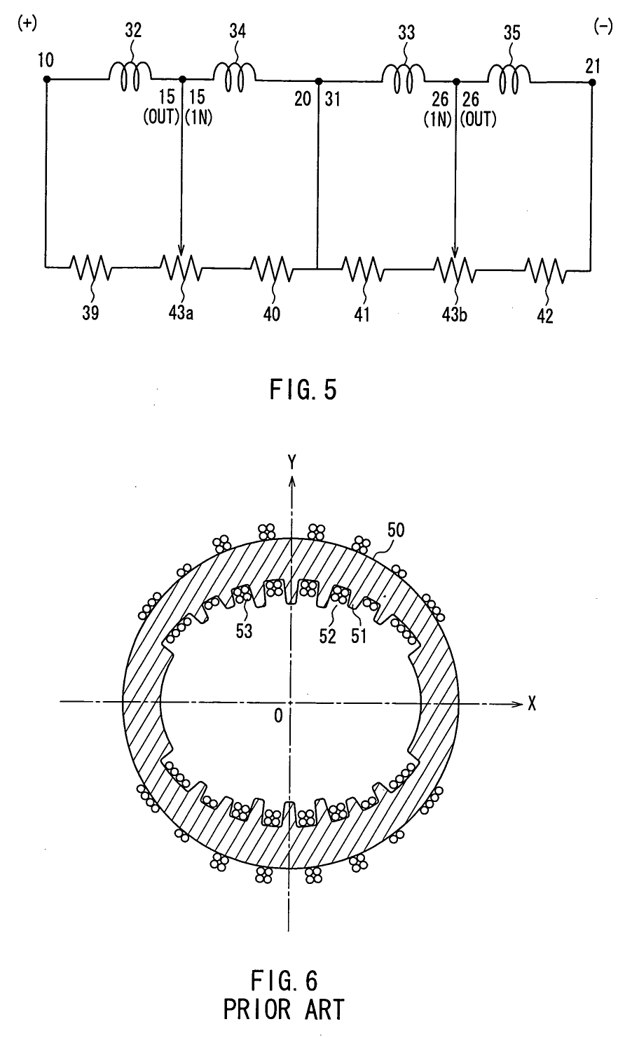

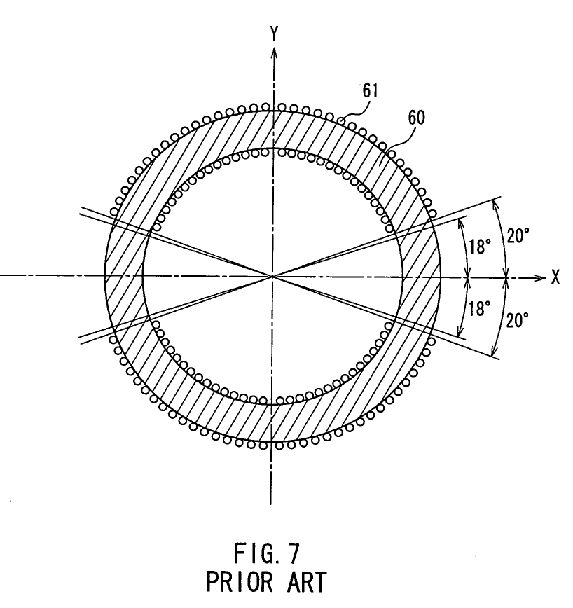

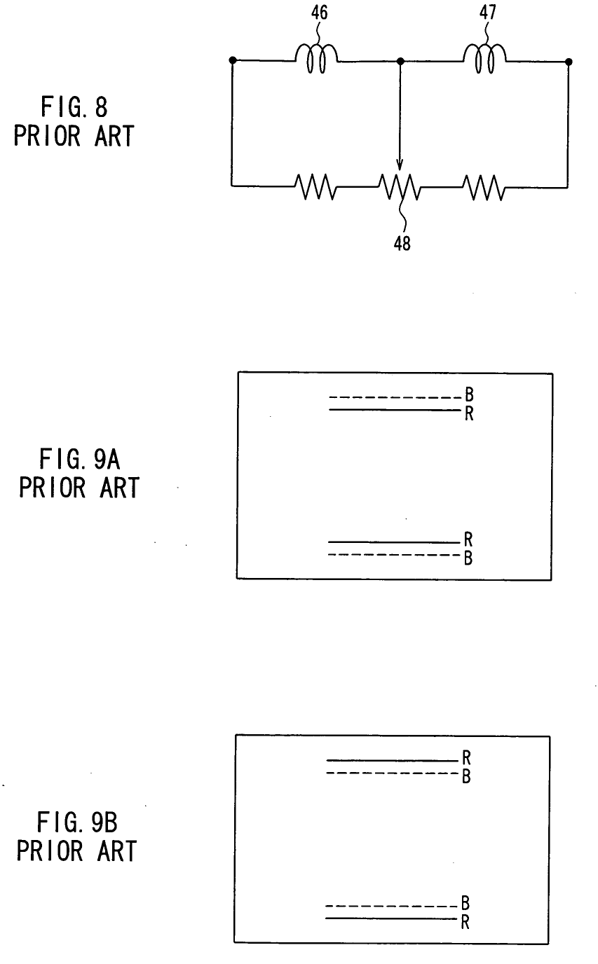

FIG. 5 shows a connection diagram according to another example of the vertical coil. The intermediate tap 15(OUT) of the upper core left coil 32 is connected to the intermediate tap 15(IN) of the upper core right coil 34. The intermediate tap 26(IN) of the lower core left coil 33 is connected to the intermediate tap 26(OUT) of the lower core right coil 35. Furthermore, the wire 20 of the upper core right coil 34 is connected to the wire 31 of the lower core left coil 33.

With this wire connection, the vertical deflection current flows through the upper core left coil 32 from the wire 10 that is connected to the positive voltage side, then flows through the upper core right coil 34, the lower core left coil 33, and the lower core right coil 35 in this order, and finally flows out through the wire 21 of the lower core right coil 35 that is connected to the negative voltage side.

With this configuration, the upper coil 8 is divided into left and right sides via the intermediate taps 15. Moreover, a 100Ω trimmer potentiometer 43a is connected to the intermediate tap 15(IN) and the intermediate tap 15(OUT). In this case, the trimmer potentiometer 43a serves as a differential resistor or variable resistor, and adjusts upper YV and top trapezoidal distortion by varying the current balance between the upper core left coil 32 and the upper core right coil 34.

Moreover, as the damping resistor, a 100Ω fixed resistor 39 and a 100Ω fixed resistor 40 are connected to the upper core left coil 32 and the upper core right coil 34, respectively, in parallel to suppress ringing.

Similarly, the lower coil 9 is divided into left and right sides via the intermediate taps 26. Moreover, a 100Ω trimmer potentiometer 43b is connected to the intermediate tap 26(IN) and the intermediate tap 26(OUT). In this case, the trimmer potentiometer 43b serves as a differential resistor or variable resistor, and adjusts lower YV and bottom trapezoidal distortion by varying the current balance between the lower core left coil 33 and the lower core right coil 35.

Moreover, as the damping resistors, a 100Ω fixed resistor 41 and a 100Ω fixed resistor 42 are connected to the lower core left coil 33 and the lower core right coil 35, respectively, in parallel to suppress ringing.

Therefore, with the configuration of the wiring diagram shown in FIG. 5, YV and top and bottom trapezoidal distortions can be adjusted in the upper and lower cores independently.

It should be noted that, as described above, even when the wire is wound using a progressive winding method, if the core is a slot core, then the wire is wound in an aligned manner around the groove portions, so that ringing, which is caused easily by, for example, asymmetry of the winding, hardly occurs.

Moreover, in the configuration shown in FIG. 5, it is possible to use two differential resistors connected in tandem so that the differential resistor 43a and the differential resistor 43b can be operated simultaneously, interconnected with each other. In this case, it is possible to use an adjustment bar that is capable of moving knobs on the differential resistors at the same time.

According to the present invention described above, YV and top and bottom trapezoidal distortions can be adjusted optimally even in a toroidal coil, and thus the present invention is useful as a color picture tube apparatus used in televisions or computer displays, for example.

The invention may be embodied in other forms without departing from the spirit or essential characteristics thereof. The embodiment disclosed in this application is to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A color picture tube apparatus, comprising a cathode ray tube and a deflection yoke that is disposed so as to surround the exterior of the cathode ray tube, in which three electron beams emitted from an electron gun are deflected by a horizontal deflection magnetic field and a vertical deflection magnetic field of the deflection yoke to form a color image on a screen,
wherein the deflection yoke comprises a horizontal deflection coil, a vertical deflection coil, and a ferrite core,
the ferrite core is divided into an upper core and a lower core, and
the vertical deflection coil is toroidally wound around each of the upper core and the lower core,
when an axis that passes through a tube axis of the cathode ray tube and extends in a vertical direction of the screen is taken as the Y axis, and an axis that passes through the tube axis and extends in a horizontal direction of the screen is taken as the X axis,
and when the ferrite core is viewed from the screen side, when a coil of the vertical deflection coil that is wound around a region located at the left of the Y axis and above the X axis is taken as an upper core left coil, a coil of the vertical deflection coil that is wound around a region located at the right of the Y axis and above the X axis is taken as an upper core right coil, a coil of the vertical deflection coil that is wound around a region located at the left of the Y axis and below the X axis is taken as a lower core left coil, and a coil of the vertical deflection coil that is wound around a region located at the right of the Y axis and below the X axis is taken as a lower core right coil,
the upper core left coil and the upper core right coil are separated via a first intermediate tap, and the lower core left coil and the lower core right coil are separated via a second intermediate tap, and
a variable resistor that is connected to at least either of the first or second intermediate tap is provided.

2. The color picture tube apparatus according to claim 1, wherein the ferrite core is a slot core on the inside or outside of which salient portions are formed.

3. The color picture tube apparatus according to claim 1, wherein a guide for regulating the winding position is added to the ferrite core.

4. The color picture tube apparatus according to claim 1,
wherein the upper core left coil and the lower core left coil are connected in series to form a left coil group, the upper core right coil and the lower core right coil are connected in series to form a right coil group, the left coil group and the right coil group are connected in series, and the variable resistor is connected to the first and second intermediate taps, and
a difference in current between the left coil group and the right coil group can be generated by the variable resistor.

5. The color picture tube apparatus according to claim 1,
wherein the variable resistor is separated into a first variable resistor and a second variable resistor,
the upper core left coil and the upper core right coil are connected in series, and the first intermediate tap is connected to the first variable resistor,
the lower core left coil and the lower core right coil are connected in series, and the second intermediate tap is connected to the second variable resistor, and
a difference in current between the upper core left coil and the upper core right coil can be generated by the first variable resistor, and a difference in current between the lower core left coil and the lower core right coil can be generated by the second variable resistor.

6. The color picture tube apparatus according to claim 5, wherein the first variable resistor and the second variable resistor are configured such that varying operations of the variable resistors are linked together.

7. The color picture tube apparatus according to claim 5, wherein the first variable resistor and the second variable resister are configured such that varying operations of the variable resistors are linked together via an adjustment bar.
